(19) United States
(12) Patent Application Publication
(10) Pub. No.: US 2008/0095863 A1
(43) Pub. Date: Apr. 24, 2008

(54) 2-PYRROLIDONE DERIVATIVES FOR PRESERVATION OF OPHTHALMIC, OTIC AND NASAL COMPOSITIONS

(75) Inventor: Bhagwati P. Kabra, Euless, TX (US)

Correspondence Address: ALCON, IP LEGAL, TB4-8, 6201 SOUTH FREEWAY, FORT WORTH, TX, 76134, US

(73) Assignee: Alcon Manufacturing Ltd., Fort Worth, TX (US)

(21) Appl. No.: 11/877,979

(22) Filed: Oct. 24, 2007

Related U.S. Application Data
(60) Provisional application No. 60/854,243, filed on Oct. 24, 2006.

(51) Int. Cl. A01N 43/36; A01N 59/16; A01P 1/00

(52) U.S. Cl. 424/641; 514/424

(57) ABSTRACT

2-Pyrrolidone derivatives are provided as preservatives for topical formulations, particularly for ophthalmic, otic, and nasal formulations. N-octyl-2-pyrrolidone, without any other preservative or preservative aid in an isotonic pH 7.5 formulation, provided sufficient preservation to comply with the European Pharmacopoeia 5.0 standards in addition to the United States Pharmacopoeia 24 standards for parenteral and ophthalmic preparations. On the other hand, N-dodecyl-2-pyrrolidone requires a second anti-microbial agent to achieve such preservation standards.

This application claims priority to U.S. Provisional Application, U.S. Ser. No. 60/854,243 filed Oct. 24, 2006.

### FIELD OF THE INVENTION

The present invention relates to the field of anti-microbial agents as preservatives for topical formulations, particularly for ophthalmic, otic, and nasal compositions.

### BACKGROUND OF THE INVENTION

Products intended for topical administration to the eyes, nose, or ears are required to pass standards for anti-microbial activity for manufacture, packaging, storage and distribution as described in the United States Pharmacopoeia (USP) and the European Pharmacopoeia (Ph.Eur.). Multi-dose products are sterilized when manufactured, but once the packaging for a product is opened, such that the composition contained therein is exposed to the atmosphere and other sources of potential microbial contamination (e.g., the hands of a human patient), the sterility of the product may be compromised.

Prior multi-dose ophthalmic compositions have generally contained one or more antimicrobial preservatives in order to prevent the proliferation of bacteria, fungi and other microbes. Such compositions will come into contact with topical surfaces such as the cornea which is particularly sensitive to exogenous chemical agents. In order to minimize the potential for harmful effects on sensitive tissues, it is preferable to use anti-microbial preservatives that are relatively non-toxic, and to use such preservatives at the lowest possible concentrations (i.e., the minimum amounts required in order to perform their anti-microbial functions).

Balancing the anti-microbial efficacy and potential toxicological effects of anti-microbial preservatives is sometimes difficult to achieve. More specifically, the concentration necessary for the preservation of formulations from microbial contamination may create the potential for toxicological effects. Using lower concentrations of the anti-microbial agents generally helps to reduce the potential for such toxicological effects, but the lower concentrations may be insufficient to achieve the required level of biocidal efficacy (i.e., antimicrobial preservation).

Numerous anti-microbial agents have been used or suggested in the art for preserving topical and pharmaceutical compositions for otic, ophthalmic or nasal applications. Such agents have included: benzalkonium chloride (BAC), chlorhexidine, alkylamines, amidoamines, polymeric biguanides, such as polyhexylmethyl biguanides (PHMB), and polymeric quaternary ammonium agents, such as polyquaternium-1. While all of these agents have offered some level of utility, their use has also led to certain limitations or drawbacks. For example, polymeric quaternary ammonium agents as well as BAC tend to complex in a detrimental way with negative ionic species typical in topical and pharmaceutical compositions. In addition, the polymeric biguanides and quaternary ammonium agents, although less irritating or toxic, have limited anti-microbial efficacy against certain species of fungi, including Aspergillus fumigatus and Aspergillus niger. Thus, a need exists for alternative anti-microbial agents that are effective on their own or for enhancing the effectiveness of these otherwise useful anti-microbial agents.

One approach to enhancing the anti-microbial activity of such compositions is to include multi-functional components as preservative aids in the compositions. In addition to performing their primary functions, multi-functional components also aid the overall anti-microbial activity of the compositions. For example, ethylenediaminetetraacetic acid, and the monosodium, disodium and trisodium salts thereof, has been widely used for many years in ophthalmic products for various purposes, particularly for its supplemental anti-microbial activity and as a chelating agent. Borate buffer systems in combination with one or more polyols, such as mannitol, aid the anti-microbial activity of compositions beyond that obtained with borate alone. Also, certain low molecular weight amino alcohols were found to be effectively and safely utilized to provide pH-buffering of ophthalmic compositions and to further aid anti-microbial activity of the compositions as described by U.S. Pat. No. 7,045,095, issued May 16, 2006 to Asgharian.

U.S. Pat. No. 5,035,859 to Gu et al., issued Jul. 30, 1991, relates to contact lens disinfecting systems and recites data for certain microbial kill by certain N-alkyl-2-pyrrolidones. N-octyl-2-pyrrolidone is reportedly used for testing kill against yeast in Examples 1, 2, 5, and in combination with chlorhexidine gluconate (a microbicide) in Example 9; the N-octyl derivative was not tested against bacteria. The N-decyl and N-dodecyl derivatives were tested against yeast and bacteria but the bacterial test was carried out only in the presence of chlorhexidine gluconate.

Certain active ingredients of ophthalmic, otic or nasal compositions may possess a charge at physiological pH and therefore can cause irritation when administered. To compensate, an agent having the opposite charge is added to the formulation, however, either or both charged species may also bind the anti-microbial agent thereby rendering the anti-microbial less effective.

In view of the foregoing, there is a need for compositions having improved anti-microbial activity and compatibility with topical and pharmaceutically active agents so as to preserve compositions from microbial contamination. The present invention is directed to satisfying this need.

### SUMMARY OF THE INVENTION

Embodiments of the present invention address the above-cited problems in the art and provide a topically acceptable ophthalmic, otic or nasal composition comprising 5-(R₁)—N—(R₂)-2-pyrrolidone in an amount to have sufficient anti-bacterial and anti-fungal activity so as to meet antimicrobial preservation criteria set forth by European Pharmacopoeia 5.0 for parenteral and ophthalmic preparations, wherein R₁ is H, methyl or ethyl; and wherein R₂ is C₆, C₇, C₈, C₉, C₁₀, or C₁₁ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; and a topically acceptable ophthalmic, otic or nasal carrier.

A self-preserved topically acceptable ophthalmic, otic or nasal composition is a further embodiment of the invention. The self-preserved composition comprises 5-(R₁)—N—(R₂)-2-pyrrolidone in an amount to have sufficient anti-bacterial and anti-fungal activity so as to meet antimicrobial preservation criteria set forth by European Pharmacopoeia 5.0 for parenteral and ophthalmic preparations, wherein R₁ is H, methyl or ethyl, and wherein R₂ is C₈ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; and a topically acceptable ophthalmic, otic or nasal carrier. In another embodiment of the composition, R₁ is H, and R₂ is octyl.

Another embodiment of the present invention provides a topically acceptable ophthalmic, otic or nasal composition comprising 5-(R₁)—N—(R₂)-2-pyrrolidone in combination with benzalkonium chloride, benzadodecinium bromide, a zinc salt, polyquaternium-1, or N-octyl-2-pyrrolidone, wherein the combination is in an amount to have sufficient anti-bacterial and anti-fungal activity so as to meet antimicrobial preservation criteria set forth by European Pharmacopoeia 5.0 for parenteral and ophthalmic preparations; wherein R₁ is H, methyl or ethyl; and wherein R₂ is C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; and a topically acceptable ophthalmic, otic or nasal carrier.

In yet a further embodiment of the invention, a topically acceptable ophthalmic, otic or nasal composition is provided comprising an 5-(R₁)—N—(R₂)-2-pyrrolidone in an amount to have sufficient anti-bacterial and anti-fungal activity so as to meet antimicrobial preservation criteria set forth by United States Pharmacopoeia 24 for parenteral and ophthalmic preparations, and a topically acceptable ophthalmic, otic or nasal carrier. In one such embodiment, R₁ is H, methyl or ethyl, and R₂ is C₈ straight-chain, branched, substituted or unsubstituted alkyl, oxyalkyl, amidoalkyl, hydroxyalkyl, alkenyl, alkynyl, cycloalkyl, alkylcycloalkyl, or alkylaryl. In a further embodiment of the composition, R₂ is C₈ straight-chain alkyl and the 5-(R₁)—N—(R₂)-2-pyrrolidone is N-octyl-2-pyrrolidone.

A further embodiment of a topically acceptable ophthalmic, otic or nasal composition having sufficient anti-bacterial and anti-fungal activity so as to meet antimicrobial preservation criteria set forth by United States Pharmacopoeia 24 for parenteral and ophthalmic preparations comprises a combination of 5-(R₁)—N—(R₂)-2-pyrrolidone with benzalkonium chloride, benzadodecinium bromide, a zinc salt, polyquaternium-1, or N-octyl-2-pyrrolidone and a topically acceptable ophthalmic, otic or nasal carrier; wherein R₁ is H, methyl or ethyl, and R₂ is C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl. In one embodiment, R₂ is C₁₂ straight-chain alkyl and the 5-(R₁)—N—(R₂)-2-pyrrolidone is N-dodecyl-2-pyrrolidone. In a further embodiment, the N-dodecyl-2-pyrrolidone is in combination with a zinc salt. In yet another embodiment, the N-dodecyl-2-pyrrolidone is in combination with polyquaternium-1.

In each of the above embodiments of the invention, the composition may further comprises an ophthalmic active, otic active, or nasal active.

In a method of preserving a topical composition from microbial contamination for use in ophthalmic, otic, or nasal administration, embodiments of the invention provide an improvement that comprises including 5-(R₁)—N—(R₂)-2-pyrrolidone in an amount to have sufficient anti-bacterial and anti-fungal activity so as to meet antimicrobial preservation criteria set forth by European Pharmacopoeia 5.0 for parenteral and ophthalmic preparations, wherein R₁ is H, methyl or ethyl, and wherein R₂ is C₆, C₇, C₈, C₉, C₁₀, or C₁₁ straight-chain, branched, substituted or unsubstituted alkyl, oxyalkyl, amidoalkyl, hydroxyalkyl, alkenyl, alkynyl, cycloalkyl, alkylcycloalkyl, or alkylaryl.

In a further method of preserving a topical composition from microbial contamination for use in ophthalmic, otic, or nasal administration, embodiments of the invention provide an improvement that comprises including 5-(R₁)—N—(R₂)-2-pyrrolidone in combination with benzalkonium chloride, benzadodecinium bromide, a zinc salt, polyquaternium-1, or N-octyl-2-pyrrolidone, wherein the combination is in an amount to have sufficient anti-bacterial and anti-fungal activity so as to meet antimicrobial preservation criteria set forth by European Pharmacopoeia 5.0 for parenteral and ophthalmic preparations; wherein R₁ is H, methyl or ethyl, and wherein R₂ is C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl.

In another method of preserving a topical composition from microbial contamination for use in ophthalmic, otic, or nasal administration, embodiments of the invention provide an improvement that comprises including N-octyl-2-pyrrolidone in an amount to have sufficient anti-bacterial and anti-fungal activity so as to meet antimicrobial preservation criteria set forth by European Pharmacopoeia 5.0 for parenteral and ophthalmic preparations. Further embodiments that provide such an improvement comprise N-dodecyl-2-pyrrolidone in combination with a zinc salt or a polyquaternium-1, the combination in an amount to have sufficient anti-bacterial and anti-fungal activity so as to meet antimicrobial preservation criteria set forth by United States Pharmacopoeia 24 for parenteral and ophthalmic preparations.

Use of any of the embodiments as set forth herein in the manufacture of a topically acceptable composition for ophthalmic, otic, or nasal use is also an embodiment of the present invention.

### DETAILED DESCRIPTION OF THE INVENTION

Filed on an even date herewith are patent applications commonly assigned to Alcon Manufacturing, Ltd. where 2-pyrrolidone derivative-containing formulations are provided as anti-bacterial agents for treatment of infections (“2-Pyrrolidone Derivatives for Treatment of Ophthalmic, Otic and Nasal Infections” to Bhagwati Kabra et al., Attorney Docket No. 45263-P028V1), (“Compositions Comprising a Quaternary Ammonium Compound and a 2-Pyrrolidone Derivative for Ionic-Type Contact Lens Care” to Masood A. Chowhan, Attorney Docket No. 45263-P033V1) and particular packaging materials therefor (“Packaging Materials for Formulations Containing 2-Pyrrolidone Derivatives” to Wesley Han et al., Attorney Docket No. 45263-P026V1). Said patent applications are incorporated by reference herein.

Embodiments of the invention provide 2-pyrrolidone derivatives or, in the case of N-dodecyl-2-pyrrolidone, combinations with another antimicrobial agent, for preservation of ophthalmic, otic or nasal formulations. As provided infra, N-octyl-2-pyrrolidone, without any other preservative or preservative aid in an isotonic pH 7.5 formulation, provided sufficient preservation to comply with the European Pharmacopoeia 5.0 standards in addition to the United States Pharmacopoeia 24 standards. On the other hand, N-dodecyl-2-pyrrolidone requires a second anti-microbial agent to achieve such preservation standards.

Unless indicated otherwise, all amounts of composition ingredients are expressed as weight/volume %.

A 2-pyrrolidone derivative. Substituents of 5-(R₁)—N—(R₂)-2-pyrrolidone of embodiments of the present invention are as follows: R₁ is H, methyl or ethyl; and R₂ is C₆, C₇, C₈, C₉, C₁₀, C₁₁, or C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl. Solubility, wetting, viscosity building, emulsifying and complexing properties of alkyl pyrrolidones as well as methods of synthesis are set forth by U.S. Pat. No. 5,294,644 to Login et al., filed Feb. 12, 1991. Method of synthesis of derivatives at the 1 and 5 positions of 2-pyrrolidone are provided by Manzer in several applications and patents assigned to DuPont, for example, U.S. Pat. No. 7,030,249 filed Sep. 8, 2004; U.S. Published Application No's. 2005/0059829 filed Oct. 15, 2004, in which 5-methyl-N-methyl-2-pyrrolidone is reported useful in antimicrobial formulations for the preservation of animal silage; 2004/0192938 filed Mar. 24, 2003; and 2004/0204593 filed Mar. 24, 2003.

Alkyl groups useful as R2 include straight-chain, branched or cyclic isomers of hexane, heptane, octane, nonane, decane, undecane, or dodecane. Representative examples of substituted alkyls include alkyls substituted by one or more functional groups as described herein. Cyclic isomers include cyclohexane, for example. Alkylcycloalkyl is a cyclic alkyl having an alkyl substituent.

Alkenyl groups useful as R2 include straight-chain, branched or cyclic isomers of hexene, heptene, octene, nonene, decene, undecene, or dodecene. Representative examples of substituted alkenyls include alkenyls substituted by one or more functional groups as described herein.

Alkynyl groups useful as R2 include straight-chain, branched or cyclic isomers of hexyne, heptyne, octyne, nonyne, decyne, undecyne, or dodecyne. Representative examples of substituted alkynyls include alkynyls substituted by one or more functional groups as described herein.

Hydroxyalkyl groups include alcohols of alkyl groups as described herein. The term “hydroxyalkyl” is meant to include glycols and diols of alkyls.

Oxyalkyl groups include the alkyl groups as herein described having ether linkages. “oxyalkyl” is meant to include polyethers with one or more functional groups. Amidoalkyl groups include the alkyl groups as herein described having nitrogen linkages.

Aryl groups include molecules having an aromatic ring structure characteristic of the 6-carbon ring of benzene, for example. An example of an alkylaryl is benzyl.

Substituents contemplated herein include halo substituents such as chloride, bromide, fluoride and iodide; and those that are carboxy-, sulfur-, nitrogen-, oxygen- or phosphorous-containing.

N-alkyl-2-pyrrolidones are nonionic surfactants that exhibit pseudo cationicity at a low pH. As the carbon number of the alkyl group increases, the solubility of N-alkyl pyrrolidones in water decreases. For example, the N-octyl-2-pyrrolidone is soluble in water up to 0.124% and the N-dodecyl-2-pyrrolidone is soluble up to 0.002%, which solubility can be improved by adding a solubility enhancer such as a surfactant or a co-solvent. N-alkyl-2-pyrrolidones are commercially available from International Specialty Products (Wayne, N.J.) or BASF Corporation (Mount Olive, N.J.), for example.

The concentration of an N-alkyl-2-pyrrolidine where the alkyl is 8-11 carbons in compositions for preservation as set forth herein is from about 0.0005 w/v % to about 1.0 w/v %, or 0.001 w/v % to about 0.1 w/v %, or from about 0.002 w/v % to about 0.05 w/v % or from about 0.01 w/v % to about 0.05 w/v %, or about 0.02 w/v % or about 0.03 w/v % or about 0.04 w/v %, or about 0.05 w/v %.

N-docecyl-2-pyrrolidone is provided herein for preservation of ophthalmic, otic or nasal formulations in combination with benzalkonium chloride, benzadodecinium bromide, a zinc salt, polyquaternium-1, or N-octyl-2-pyrrolidone. The concentration of N-dodecyl-2-pyrrolidine in combination compositions is from about 0.0005 w/v % to about 1.0 w/v %, or 0.001 w/v % to about and including 0.002 w/v % and, when present with a solubility enhancer, from about 0.002 w/v % to about 0.01 w/v % or to about 0.05 w/v %. A zinc salt may be a zinc halide such as zinc chloride; or zinc sulfate, zinc acetate or zinc carbonate, for example.

Ophthalmic active, otic active, or nasal active. An active included in compositions herein include all ophthalmic, otic or nasal pharmaceutical agents that can be topically applied. For example, active pharmaceuticals may include (but are not limited to): anti-glaucoma agents, such as beta-blockers; muscarinics (e.g., pilocarpine), prostaglandins, prostaglandin analogues; carbonic anhydrase inhibitors (e.g., brinzolamide, acetazolamide, methazolamide and ethoxzolamide), dopaminergic agonists and antagonists, and alpha adrenergic receptor agonists, such as dipivefrin, epinephrine, proepinephrine, norepinephrine; pronorepinephrine, para-amino clonidine (also known as apraclonidine) and brimonidine; anti-infectives; non-steroidal and steroidal anti-inflammatories; proteins; growth factors, such as EGF; serotonergic agents such as AL-37807; and anti-allergic agents, such as cromolyn sodium, emedastine and olopatadine. Compositions of embodiments of the present invention may also include combinations of active ingredients. The active component may be present at a level of about 0.0001 w/v % to 4.0 w/v %, from about 0.001 w/v % to 1.0 w/v %, or from about 0.001 w/v % to 0.5 w/v %, or from about 0.002 w/v % to 0.5 w/v %.

Examples of beta-blocker actives include acebutolol, atenulol, azotinolol (S-596), befunolol, betaxolol, bunalol, bupranolol, carteolol, celiprolol, diacetolol, esmalol, hepunolol, isoxaprolol, labetalol, levobetaxolol, metaprolol, metipranolol, pindolol, propranolol, salbutamol, timolol, and the like.

Examples of prostaglandin analogue actives include cloprostenol, fluprostenol, latanoprost, bimatoprost, or travoprost.

Examples of anti-infective actives include ciprofloxacin, moxifloxacin and trovafloxacin.

Examples of a steroidal anti-inflammatory active include glucocorticoids such as dexamethasone and derivatives thereof such as the 21-ether derivatives, loteprednol, rimexolone, prednisolone, fluorometholone, and hydrocortisone particularly for ophthalmic and otic use, and mometasone, fluticasone, beclomethasone, flunisolide, triamcinolone and budesonide particularly for nasal use.

Examples of a nonsteroidal anti-inflammatory active include agents such as prostaglandin H synthetase inhibitors (Cox I or Cox II), also referred to as cyclooxygenase type I and type II inhibitors, such as diclofenac, flurbiprofen, ketorolac, suprofen, nepafenac, amfenac, indomethacin, naproxen, ibuprofen, bromfenac, ketoprofen, meclofenamate, piroxicam, sulindac, mefanamic acid, diflusinal, oxaprozin, tolmetin, fenoprofen, benoxaprofen, nabumetome, etodolac, phenylbutazone, aspirin, oxyphenbutazone, NCX-4016, HCT-1026, NCX-284, NCX-456, tenoxicam and carprofen; cyclooxygenase type II selective inhibitors, such as NS-398, vioxx, celecoxib, P54, etodolac, L-804600 and S-33516; PAF antagonists, such as SR-27417, A-137491, ABT-299, apafant, bepafant, minopafant, E-6123, BN-50727, nupafant and modipafant; PDE IV inhibitors, such as ariflo, torbafylline, rolipram, filaminast, piclamilast, cipamfylline, CG-1088, V-11294A, CT-2820, PD-168787, CP-293121, DWP-205297, CP-220629, SH-636, BAY-19-8004, and roflumilast; inhibitors of cytokine production, such as inhibitors of the NFkB transcription factor; or other anti-inflammatory agents known to those skilled in the art. The concentration of the anti-inflammatory agent is an effective amount and is typically an amount of from about 0.01 to about 1.0 weight %.

The term “anionic active,” as used herein, means an active ingredient that has, or is capable of having a negative charge during formulation of the final product or as formulated in the final product. Diclofenac and suprofen are examples of anionic actives.

The term “cationic active,” as used herein, means an active ingredient that has, or is capable of having a positive charge during formulation of the final product or as formulated in the final product.

N-alkyl-2-pyrrolidones as provided herein are particularly useful for preservation of compositions comprising anionic actives or anionic polymers such as anionic polyelectrolytes or negatively charged ion exchange resins since common preservatives such as BAC, benzadodecinium bromide, and polyquaternium-1 are positively charged and tend to complex with such anionic ingredients.

Further Ingredients. Preservation compositions as provided herein may contain further topically acceptable or pharmaceutically acceptable ingredients for ophthalmic, otic or nasal use such as a further preservative, a preservative aid, a viscosity modifying agent, a tonicity agent, a buffer, a pH adjusting agent, a drug carrier, a surfactant, a chelating agent, a sustained release agent, a comfort-enhancing agent, a solubilizing aid, an antioxidant, a stabilizing agent, or a combination thereof, for example. One of ordinary skill in the art realizes that an ingredient may contribute more than one property to the formulation.

Examples of further preservatives include those known to one of ordinary skill in the art such as monomeric or polymeric quaternary ammonium preservatives, such as benzalkonium halides (benzalkonium chloride (BAC) or benzalkonium bromide, for example), benzadodecinium bromide, and polyquatemium-1 (also known as ONAMER M® (Onyx Chemical Corporation) or as POLYQUAD® (Alcon Laboratories, Inc., Fort Worth, Tex.)). In general, the amount of further preservative present in the compositions herein is from about 0.00001 w/v % to 4.0 w/v %, from about 0.001 w/v % to 1.0 w/v %, or from about 0.01 w/v % to 0.5 w/v %, 1% to about 0.6%, or from about 0.3% to about 0.4%. In the case of benzalkonium chloride, the preservative is present in an amount from about 0.001 to about 0.02%, or from about 0.005% to about 0.01%. In the case of polyquatemium-1, the preservative is present in an amount of from about 0.00001 w/v % to about 0.005 w/v % or to about 0.001 w/v %. In the case of zinc as a preservative, the preservative is present in an amount to contain zinc ions at a concentration between about 0.04 mmol/L and about 0.4 mmol/L.

Further examples of preservatives or preservation aids include, for example, chlorobutanol; cetylpyridinium chloride; chlorine dioxide; parabens; biguanides such as chlorhexidine, polyhexamethylene biguanide, and polyaminopropyl biguanide; boric acid, benzoic acid, salicylic acid, sorbic acid, lactic acid, acetic acid, and topically acceptable salts thereof; borate/polyol complexes, or a combination thereof. A further preservation aid is lauroyl sarcosine available from W. R. Grace (Lexington, Mass.) as HAMPOSYL®L.

The use of viscosity enhancing agents to provide the compositions herein with viscosities greater than the viscosity of simple aqueous solutions may be desirable to increase ocular absorption of the active compounds by the target tissues or increase the retention time in the eye, ear or nose. Such viscosity building agents include, for example, polyvinyl alcohol, polyvinyl pyrrolidone, methyl cellulose, hydroxypropyl methylcellulose, hydroxyethyl cellulose, carboxymethyl cellulose, hydroxypropyl cellulose, carbomers, xanthan gum, gellan gum, guar gum, a combination thereof, or other agents know to those skilled in the art. Such agents are typically employed at a level of from 0.01% to 3% by weight.

Embodiments of compositions herein may contain a topically acceptable tonicity-adjusting agent such as, for example, metal chloride salts such sodium chloride, potassium chloride, calcium chloride or magnesium chloride; and non-ionic tonicity-adjusting agents such as mannitol, sorbitol, dextrose, glycerine, propylene glycol, polyethylene glycol or a combination thereof. The amount of tonicity adjusting agent contained in the compositions is an amount sufficient to cause the composition to have an osmolality of about 150 mOsm/kg to about 400 mOsm/kg of water, or about 230 mOsm/kg to 350 mOsm/kg, or about 260 mOsm/kg to 330 mOsm/kg. The concentration of tonicity agent in the composition may be from about 0.1 w/v % to about 10 w/v %, from about 0.2 w/v % to about 5 w/v %, or from about 1.0 w/v % to about 2.0 w/v %. For example, where the tonicity adjusting agent is a combination of sodium chloride and mannitol, the amount of sodium chloride is about 0.1% to about 0.8% and the amount of mannitol is about 0.01% to 10% in the final product.

Embodiment of compositions of the present invention have a pH from about 5.0 to 9.0 or from about pH 6.0 to 8.0, or about pH 7.0 to about 7.8, or about pH 7.5. The compositions contain a topically acceptable pH-adjusting agent or buffer in order to achieve the desired pH. Topically acceptable pH adjusting agents and buffers are known and include, for example, hydrochloric acid (HCl), sodium hydroxide (NaOH), triethanolamine, borates, borate-polyols, phosphates, citrates, acetates, carbonates, tris-hydroxymethylaminomethane (tromethamine), or a combination thereof.

The solubility of 2-pyrrolidones of the present compositions may be enhanced by a surfactant or other appropriate co-solvent in the composition in an amount from about 0.01 w/v %-10 w/v %, from 0.02 w/v % to about 5.0 w/v %, or from about 0.05 w/v % to about 1.0 w/v %. A surfactant may be nonionic, anionic, cationic, amphoteric, or amphiphilic. Exemplary nonionic surfactants or co-solvents include tyloxapol, polyoxyethylene sorbitan esters, polyethoxylated castor oils, polyethoxylated hydrogenated castor oils such as HCO-40, poloxamers, polyoxyethylene/polyoxypropylene surfactants, polyoxyethylene lauryl ether, polyoxyethylene stearate, polyoxyethylene propylene glycol stearate, hydroxyalkylphosphonate, a combination thereof, or other agents known to those skilled in the art.

Embodiments of compositions herein may contain a chelating agent such as, for example, ethylene diamine tetraacetic acid (EDTA); ethylene glycol-bis-(b-aminoethylether)-N,N,N′,N′-tetraacetic acid (EGTA), 1,2-bis(2-aminophenoxy)ethane-N,N,N′,N′-tetraacetic acid (BAPTA), ethylene-N,N′-diglycine (EDDA), 2,2′-(ethylendiimino)-dibutyric acid (EDBA), diethyleneamine pentaacetate, topically acceptable salts thereof, and the like. A topically acceptable salt, for example, of EDTA is edetate disodium, edetate trisodium or edetate tetrasodium. Further examples of a chelating agent include low molecular weight amino acids having an alpha carboxylic acid group such as those set forth by U.S. Pat. No. 5,741,817 to Chowhan et al., issued Apr. 21, 1998, herein incorporated by reference. In general, the amount of chelating agent present in the compositions herein is from about 0.001% to about 1%, about 0.01% to about 0.2%, or about 0.01% to about 0.1%. Chelating agents are also described as preservation aids.

An ion exchange resin component of the formulations of the present invention provides a means of sustained release of an active having a positive or negative charge. In addition, use of an ion exchange resin reduces irritation of charged actives. The average particle size of the commercially available forms of the resins is about 40 to 150 microns. For topically administrable compositions, particularly ophthalmic compositions, commercially available resin particles are reduced by known techniques, including grinding, ball milling and microfluidization, to a particle size of about 20 microns or less, such that the average particle size is about 10 microns or less. Ion exchange resins are typically used in an amount from about 0.05 w/v % to about 10 w/v %, for from about 0.1 w/v % to 1.0 w/v % or about 0.5 w/v %. An ion exchange resin is generally used in a 0.25:1 to 2.5:1 ratio with the active and in another embodiment is used in a 1:1 ratio with the active.

Topical grade ion exchange resins are available, for example, under the “AMBERLITE®” trade name from Rohm & Haas and under the “DOWEX®” trade name from Dow Chemical Co. Suitable resins include, for example, AMBERLITE® IRP-69, AMBERLITE® IR-118H and AMBERLYST® 131 (4% cross-linking).

A carboxyvinyl polymer (carbomers or carboxypolymethylenes) may also be present as a thickening or physical stability-enhancing agent. Carbomers are commercially available from sources such as Noveon, Inc. (CARBOPOL®, Cleveland, Ohio). Carbopol polymers are acrylic acid-based polymers cross-linked with allyl sucrose or allylpentaerythritol; an example of which is CARBOPOL® 974P. The concentration of carbomer in the compositions of the present invention will generally range from about 0.05% to about 0.6%, from about 0.1% to about 0.5% and about 0.2%. Anionic polyelectrolytes, such as high molecular weight (e.g., 50,000-6,000,000), may also serve as sustained release agents. Further anionic agents include anionic mucomimetic polymers (e.g., carboxyvinyl polymers, such as CARBOPOL®, and xanthan gum), and polystyrene sulfonic acid polymers and cationic exchange resins.

Ophthalmic compositions as provided herein include compositions formulated for the treatment of dry eye-type diseases and disorders. Such compositions may comprise aqueous carriers designed to provide immediate, short-term relief of dry eye-type conditions. Such carriers can be formulated as a phospholipid carrier or an artificial tears carrier, or mixtures thereof. As used herein, “phospholipid carrier” and “artificial tears carrier” refer to aqueous compositions that: (i) comprise one or more phospholipids (in the case of phospholipid carriers) or other compounds, that lubricate, “wet,” approximate the consistency of endogenous tears, aid in natural tear build-up, or otherwise provide temporary relief of dry eye symptoms and conditions upon ocular administration; (ii) are safe; and (iii) provide the appropriate delivery vehicle for the topical administration of an effective amount of one or more actives. Examples of artificial tears compositions useful as artificial tears carriers include, but are not limited to, commercial products, such as TEARS NATURALE®, TEARS NATURALE II®, TEARS NATURALE FREE®, and BION TEARS® (Alcon Laboratories, Inc., Fort Worth, Tex.). Examples of phospholipid carrier formulations include those disclosed in U.S. Pat. Nos. 4,804,539 (Guo et al.), 4,883,658 (Holly), 4,914,088 (Glonek), 5,075,104 (Gressel et al.), 5,278,151 (Korb et al.), 5,294,607 (Glonek et al.), 5,371,108 (Korb et al.), 5,578,586 (Glonek et al.); the foregoing patents are incorporated herein by reference to the extent they disclose phospholipid compositions useful as phospholipid carriers of the present invention.

Molded containers are generally used for packaging compositions of the present invention and are generally made from polyethylene, polyethylene terephthalate (PETE) or polypropylene. However, as described by a patent application filed on an even date herewith (“Packaging Materials For Formulations Containing 2-Pyrrolidone Derivatives” to Wesley Han, et al., Atty Docket No. 45263-P026V1) and incorporated by reference herein as cited previously, certain types of packaging have been found unsuitable for formulations containing 2-pyrrolidone derivative compounds. Polyethylene terephthalate, fluoropolymers and polystyrene appear to be the optimal materials for packaging; however polyethylene or polypropylene may be used when provided with an inner coating of a material that lacks adsorptive or absorptive properties for the 2-pyrrolidone derivative.

The anti-microbial compositions of the present invention can be used in all types of topically administrable compositions (e.g., solutions, suspensions, emulsions, gels, ointments). In embodiments of the invention, the compositions are used for topically administrable ophthalmic, otic, or nasal formulations. The compositions are typically administered to the affected ophthalmic, otic or nasal tissues by topically applying one to four drops of a sterile solution or suspension, or a comparable amount of an ointment, gel or other solid or semisolid composition, one to four times per day.

Administration may be directly to the ear via, for example, topical otic drops or ointments, slow release devices in the ear or implanted adjacent to the ear. Furthermore, agents can be administered to the middle or inner ear by placement of a gelfoam, or similar absorbent and adherent product, soaked with the agent against the window membrane of the middle/inner ear or adjacent structure.

Administration may be directly to the nasal and sinus area, via, for example, nose drops, an aerosolized preparation, and by inhalation via an inhaler or a nebulizer, for example.

The phrase “topically acceptable” is employed herein to refer to those compounds, materials, compositions, and/or dosage forms which are, within the scope of sound medical judgment, suitable for use in contact with tissues of human beings and animals and without excessive toxicity, irritation, allergic response, or any other problem or complication, commensurate with a reasonable benefit/risk ratio. A “topically acceptable” material includes those materials that are pharmaceutically acceptable. The amounts of ingredients of formulations provided for efficacy depends upon factors, such as means of administration, the target site, the physiology of the subject, and other medications administered. Therefore, treatment dosages are titrated to optimize safety and efficacy. Generally, dosages used in vitro provide guidance in the amounts useful for in vivo delivery

Antimicrobial preservative effectiveness as set forth by the examples infra was determined using an organism challenge test according to the methods described in the United States Pharmacopoeia 24 (USP) for category 1A products, and in European Pharmacopoeia 5.0 (Ph. Eur.) for parenteral and ophthalmic preparations. Samples were inoculated with known levels of one or more of the following: gram-positive vegetative bacteria (Staphylococcus aureus ATCC 6538), gram-negative vegetative bacteria (Pseudomonas aeruginosa ATCC 9027 and Escherichia coli ATCC 8739), yeast (Candida albicans ATCC 10231) and mold (Aspergillus niger ATCC 16404). The samples were then pulled at specified intervals to determine if the antimicrobial preservative system was capable of killing or inhibiting the propagation of organisms purposely introduced into the formulation. The rate or level of antimicrobial activity determines compliance with the USP and/or Ph. Eur. preservative efficacy standards for the cited categories of preparations.

The preservative standards are presented by Table 1.

TABLE 1
Preservative Standards for U.S. Category 1A Products
and for EP Parenteral and Ophthalmic Preparations presented
as Log Reduction of Organism Population

| Time Pulls | | | | |
|---|---|---|---|---|
| 6 hours | 24 hours | 7 days | 14 days | 28 days |

For Bacteria (S. aureus, P. aeruginosa, and E. coli)*

| | | | | | |
|---|---|---|---|---|---|
| USP | — | — | 1.0 | 3.0 | NI |
| Ph. Eur. B | — | 1.0 | 3.0 | — | NI |
| Ph. Eur. A | 2.0 | 3.0 | — | — | NR |

For Fungi (C. albicans and A. niger)

| | | | | | |
|---|---|---|---|---|---|
| USP | — | — | NI | NI | NI |
| Ph. Eur. B | — | — | — | 1.0 | NI |
| Ph. Eur. A | — | — | 2.0 | — | NI |

*There is no requirement to test for E. coli for Ph Eur. standards.
— = no requirement at this time pull
NI = No increase at this or any following time pulls
NR = No organisms recovered

As cited by Table 1, the USP 24 Antimicrobial Effectiveness Test requires that compositions containing Category 1A products have sufficient anti-bacterial activity to reduce an initial inoculum of approximately 10⁵ to 10⁶ bacteria by one log (i.e., a 90% reduction in the microorganism population) over a period of seven (7) days and by three logs (i.e., a 99.9% reduction in the microorganism population) over a period of fourteen (14) days, and requires that there cannot be any increase in the microorganism population following the conclusion of the fourteen day period. Relative to fungi, the USP standards require that the compositions maintain stasis (i.e., no growth) relative to the population of the initial inoculum over the entire 28 day test period. A category 1A product is an injection, or other parenteral including emulsions, otic, sterile nasal products and ophthalmic products made with aqueous bases or vehicles.

The margin of error in calculating microorganism populations is generally accepted to be +/−0.5 logs. Accordingly, the term “stasis”, as utilized herein relative to the above-discussed USP standards, means that the initial population cannot increase by more than 0.5 log orders, relative to the initial population.

As cited by Table 1, the Ph. Eur. B Effectiveness Test for parenteral and ophthalmic preparations requires that multi-dose compositions have sufficient anti-bacterial activity to reduce an initial inoculum of approximately 10⁵ to 10⁶ bacteria by one log(i.e., a 90% reduction in the microorganism population) over a period of one (1) day and by three logs (i.e., a 99.9% reduction in the microorganism population) over a period of seven (7) days, and requires that there cannot be any increase in the microorganism population following the conclusion of a 28-day period. Regarding fungi, the Ph. Eur. B standard requires that the compositions have sufficient anti-fungal activity to reduce an initial inoculum of approximately 10⁵ to 10⁶ organisms by one log(i.e., a 90% reduction in the microorganism population) over a period of fourteen (14) days and maintain stasis (i.e., no growth) relative to the population of the initial inoculum over the entire 28 day test period.

The following examples are presented to further illustrate embodiments of the invention.

### EXAMPLE 1

### Anti-Microbial Properties of N-Octyl-2-Pyrrolidone

The formulation set forth by Table 2 was made by adding the N-octyl-2-pyrrolidone aseptically after the other ingredients were combined. The formulation was screened for anti-microbial efficacy as follows.

TABLE 2
Anti-Microbial Efficacy Screen Test

| Ingredient | Concentration (w/v %) | | |
|---|---|---|---|
| N-Octyl-2-Pyrrolidone | 0.05 | | |
| Propylene Glycol | 1.8 | | |
| Dibasic sodium phosphate (anhydrous) | 0.04 | | |
| Monobasic sodium phosphate | 0.01 | | |
| (monohydrate) | | | |
| Sodium hydroxide and/or | Adjust pH to 7.5 | | |
| Hydrochloric Acid | | | |
| Purified water | qs 100 | | |
| | Log Order Reductions | | |
| Microorganism | 6 hours | 24 hours | 7 days |
| S. aureus | 4.9 | 4.9 | 4.9 |
| P. aeruginosa | 4.9 | 4.9 | 4.9 |
| E. coli | 5.0 | 5.0 | 5.0 |
| C. albicans | — | — | 4.8 |
| A. niger | — | — | 0.7 |

—: not done

The screening data obtained at 24 hours and at 7 days as cited by Table 2 indicate that a composition having 0.05% N-octyl-2-pyrrolidone provided essentially complete kill of both gram-negative and gram-positive bacteria in six hours and essentially complete kill of Candida albicans in 7 days. These screening results demonstrate that N-octyl-2-pyrrolidone has anti-microbial properties and provided the basis for further testing of preservative efficacy.

### EXAMPLE 2

### Anti-Microbial Properties of N-Octyl-2-Pyrrolidone in the Presence of an Active

Pharmaceutical actives that are charged at physiological pH provide a particular challenge for meeting the Ph. Eur. B standards for preservation. Compositions that contain a positively charged active and a negatively charged excipient to bind the active also provide a particular challenge for meeting the Ph. Eur. B standards for preservation. The negatively charged excipient may readily bind a conventional preservative and render it less effective.

AL-37807 is a serotonergic agent having a positive charge at physiological pII and can be formulated with a cationic exchange resin, AMBERLITE® IRP69 which essentially neutralizes the charge. Such a combination has a disadvantage in that a conventional preservative such as benzalkonium chloride (BAC) also is bound by the cationic exchange resin rendering the BAC less effective.

Table 3 presents anti-microbial preservation results with N-octyl-2-pyrrolidone in the absence of BAC. Formulations are made as for Example 1.

TABLE 3
Anti-Microbial Activity with N-Octyl-2-Pyrrolidone
in Absence of BAC (a control for data of Table 4.)

| | | | Concentration (w/v %) | | | | |
|---|---|---|---|---|---|---|---|
| Ingredient | | | A (Control) | B | C | D | E |
| AL-37807 | | | 1 | 1 | 0.5 | 0.5 | 0.5 |
| Carbopol 974P | | | 0.2 | 0.22 | — | — | — |
| Xanthan Gum | | | — | — | 0.6 | 0.6 | 0.6 |
| Amberlite IRP69 | | | 0.5 | 0.5 | 0.5 | 0.5 | 0.6 |
| Mannitol | | | 4.5 | — | — | — | — |
| Propylene Glycol | | | — | 1.9 | 1.6 | 1.6 | 1.4 |
| Edetate Disodium | | | 0.01 | — | 0.01 | 0.01 | 0.01 |
| BAC | | | 0.01 | — | — | — | — |
| HCO-40 | | | — | — | — | 0.05 | — |
| N-Octyl-2-Pyrrolidone | | | — | 0.05 | 0.05 | 0.05 | 0.05 |
| Boric Acid | | | — | — | 0.1 | 0.1 | 0.2 |
| Sorbitol | | | — | — | — | — | 0.2 |
| HCl or NaOH | | | qs pH 7.5 | qs pH 7.5 | qs pH 7.5 | qs pH 7.5 | qs pH 7.5 |
| Purified water | | | qs 100 | qs 100 | qs 100 | qs 100 | qs 100 |
| Microorganism | | | Log Order Reductions | | | | |
| S. aureus | 6 | Hr | 0.0 | 2.4 | 0.8 | 0.8 | 0.6 |
| | 24 | Hr | 0.2 | 4.8 | 3.4 | 2.8 | 4.3 |
| | 7 | D | 4.9 | 4.8 | 4.8 | 4.8 | 4.9 |
| | 14 | D | 4.9 | 4.8 | 4.8 | 4.8 | 4.9 |
| | 28 | D | 4.9 | 4.8 | 4.8 | 4.8 | 4.9 |
| P. aeruginosa | 6 | Hr | 5.0 | 4.9 | 4.9 | 4.9 | 5.0 |
| | 24 | Hr | 5.0 | 4.9 | 4.9 | 4.9 | 5.0 |
| | 7 | D | 5.0 | 4.9 | 4.9 | 4.9 | 5.0 |
| | 14 | D | 5.0 | 4.9 | 4.9 | 4.9 | 5.0 |
| | 28 | D | 5.0 | 4.9 | 4.9 | 4.9 | 5.0 |
| E. coli | 6 | Hr | 0.5 | 5.0 | 5.0 | 5.0 | 5.0 |
| | 24 | Hr | 2.3 | 5.0 | 5.0 | 5.0 | 5.0 |
| | 7 | D | 5.0 | 5.0 | 5.0 | 5.0 | 5.0 |
| | 14 | D | 5.0 | 5.0 | 5.0 | 5.0 | 5.0 |
| | 28 | D | 5.0 | 5.0 | 5.0 | 4.9 | 5.0 |
| C. albicans | 7 | D | 2.0 | 4.9 | 4.9 | 4.9 | 4.9 |
| | 14 | D | 2.6 | 4.9 | 4.9 | 4.9 | 4.9 |
| | 28 | D | 4.6 | 4.9 | 4.9 | 4.9 | 4.9 |
| A. niger | 7 | D | 0.3 | 0.9 | 1.1 | 0.7 | 3.0 |
| | 14 | D | 0.6 | 2.0 | 2.4 | 1.7 | 3.1 |
| | 28 | D | 1.7 | 2.0 | 2.6 | 2.5 | 3.8 |

Compositions of Table 3 having N-octyl-2-pyrrolidone present (i.e., B, C, D, and E) pass the USP and Ph.Eur. B criteria as set forth by Table 1. Compositions B, C, D, and E variously have boric acid, sorbitol, surfactant HCO-40, edetate disodium, xanthum gum or CARBOPOL 974P absent. In addition, compositions having N-octyl-2-pyrrolidone present pass the cited criteria in the presence of the cationic active and the cation exchange resin Amberlite IRP69. Therefore, N-octyl-2-pyrrolidone is effective as a sole preservative for meeting the Ph. Eur B standards.

Table 4 presents anti-microbial preservation results with N-octyl-2-pyrrolidone in the presence of BAC. The formulations are made as for Example 1.

TABLE 4
Anti-Microbial Activity with N-Octyl-2-Pyrrolidone
in the Presence of BAC

| | | | Concentration (w/v %) | | |
|---|---|---|---|---|---|
| Ingredient | | | A (Control) | F | G |
| AL37807 | | | 1 | 1 | 1 |
| Carbopol 974P | | | 0.2 | 0.2 | 0.2 |
| Amberlite IRP69 | | | 0.5 | 0.5 | 0.5 |
| Mannitol | | | 4.5 | — | 4.5 |
| Propylene Glycol | | | — | 1.8 | — |
| Edetate Disodium | | | 0.01 | 0.01 | 0.01 |
| BAC | | | 0.01 | 0.01 | 0.01 |
| N-Octyl-2-Pyrrolidone | | | — | 0.01 | 0.05 |
| HCl or NaOH | | | qs pH 7.5 | qs pH 7.5 | qs pH 7.5 |
| Purified Water | | | qs 100 | qs 100 | qs 100 |
| Microorganism | | | Log Order Reductions | | |
| S. aureus | 6 | Hr | 0.0 | 0.1 | 2.8 |
| | 24 | Hr | 0.2 | 1.2 | 4.8 |
| | 7 | D | 4.9 | 4.4 | 4.8 |
| | 14 | D | 4.9 | 4.8 | 4.8 |
| | 28 | D | 4.9 | 4.8 | 4.8 |
| P. aeruginosa | 6 | Hr | 5.0 | 4.9 | 4.9 |
| | 24 | Hr | 5.0 | 4.9 | 4.9 |
| | 7 | D | 5.0 | 4.9 | 4.9 |
| | 14 | D | 5.0 | 4.9 | 4.9 |
| | 28 | D | 5.0 | 4.9 | 4.9 |
| E. coli | 6 | Hr | 0.5 | 0.9 | 4.9 |
| | 24 | Hr | 2.3 | 3.0 | 4.9 |
| | 7 | D | 5.0 | 5.0 | 4.9 |
| | 14 | D | 5.0 | 5.0 | 4.9 |
| | 28 | D | 5.0 | 5.0 | 4.9 |
| C. albicans | 7 | D | 2.0 | 3.1 | 4.8 |
| | 14 | D | 2.6 | 4.9 | 4.8 |
| | 28 | D | 4.6 | 4.9 | 4.8 |
| A. niger | 7 | D | 0.3 | 0.7 | 1.7 |
| | 14 | D | 0.6 | 1.0 | 2.0 |
| | 28 | D | 1.7 | 2.5 | 2.2 |

Compositions of Table 4 having N-octyl-2-pyrrolidone present (i.e., F and G) pass the USP and Ph.Eur. B criteria as set forth by Table 1. In addition, compositions having N-octyl-2-pyrrolidone present pass the cited criteria in the presence of a cationic active, the cation exchange resin Amberlite IRP69, and BAC.

Table 5 provides data regarding the anti-microbial efficacy of N-octyl-2-pyrrolidone in the presence of cationic active, the cation exchange resin Amberlite IRP69, BAC and HCO-40.

TABLE 5
Anti-Microbial Activity of N-Octyl-2-Pyrrolidone
in the Presence of BAC and HCO-40

| | | | Concentration (w/v %) | | |
|---|---|---|---|---|---|
| Ingredient | | | A (control) | H | I |
| AL37807 | | | 1 | 1 | 1 |
| Carbopol 974P | | | 0.2 | 0.2 | 0.2 |
| Amberlite IRP69 | | | 0.5 | 0.5 | 0.5 |
| Mannitol | | | 4.5 | — | — |
| Propylene Glycol | | | — | 1.8 | 1.9 |
| Edetate Disodium | | | 0.01 | 0.01 | 0.01 |
| BAC | | | 0.01 | 0.01 | 0.01 |
| HCO-40 | | | — | 0.05 | 0.05 |
| N-Octyl-2-Pyrrolidone | | | None | 0.02 | 0.05 |
| HCl or NaOH | | | qs pH 7.5 | qs pH 7.5 | qs pH 7.5 |
| Purified Water | | | qs 100 | qs 100 | qs 100 |
| Microorganism | | | Log Order Reductions | | |
| S. aureus | 6 | Hr | 0.0 | 0.1 | 4.8 |
| | 24 | Hr | 0.2 | 2.4 | 4.8 |
| | 7 | D | 4.9 | 4.8 | 4.8 |
| | 14 | D | 4.9 | 4.8 | 4.8 |
| | 28 | D | 4.9 | 4.8 | 4.8 |
| P. aeruginosa | 6 | Hr | 5.0 | 4.9 | 4.8 |
| | 24 | Hr | 5.0 | 4.9 | 4.8 |
| | 7 | D | 5.0 | 4.9 | 4.8 |
| | 14 | D | 5.0 | 4.9 | 4.8 |
| | 28 | D | 5.0 | 4.9 | 4.8 |
| E. coli | 6 | Hr | 0.5 | 1.6 | 5.0 |
| | 24 | Hr | 2.3 | 5.0 | 5.0 |
| | 7 | D | 5.0 | 5.0 | 5.0 |
| | 14 | D | 5.0 | 5.0 | 5.0 |
| | 28 | D | 5.0 | 5.0 | 5.0 |
| C. albicans | 7 | D | 2.0 | 3.8 | 4.9 |
| | 14 | D | 2.6 | 4.9 | 4.9 |
| | 28 | D | 4.6 | 4.9 | 4.9 |
| A. niger | 7 | D | 0.3 | 0.6 | 2.1 |
| | 14 | D | 0.6 | 1.7 | 2.8 |
| | 28 | D | 1.7 | 2.4 | 3.1 |

Compositions of Table 5 having N-octyl-2-pyrrolidone present (i.e., H and I) pass the USP and Ph.Eur. B criteria as set forth by Table 1. In addition, compositions having N-octyl-2-pyrrolidone present pass the cited criteria in the presence of a cationic active, the cation exchange resin Amberlite IRP69, BAC and the surfactant HCO-40. In this combination, the surfactant HCO-40 encourages micelle formation.

### EXAMPLE 3

### Anti-Microbial Properties of N-Dodecyl-2-Pyrrolidone

As cited in Example 2, active pharmaceuticals that have a net positive or negative charge at physiological pH provide a particular challenge for meeting the Ph. Eur. B standard in that the an anionic pharmaceutical active or a negatively charged excipient added to a cationinc active may readily bind a conventional preservative and render it less effective.

The formulation set forth by Table 6 was made by adding the N-dodecyl-2-pyrrolidone aseptically after the other ingredients were combined. The formulation was screened for anti-microbial preservation results in the absence of BAC to provide control data for the study of Table 7.

TABLE 6
Anti-Microbial Activity with N-Dodecyl-2-Pyrrolidone in the Absence of BAC

| | | | Concentration (w/v %) | | |
|---|---|---|---|---|---|
| Ingredient | | | O | P | Q |
| BAC | | | — | — | — |
| Boric Acid | | | 0.3 | 0.3 | None |
| 1-Dodecyl-2- | | | 0.001 | 0.001 | 0.001 |
| Pyrrolidone | | | | | |
| Sorbitol | | | 0.25 | 0.25 | — |
| Propylene Glycol | | | 1.6 | 1.6 | 2.0 |
| NaOH and/or HCl | | | qs pH 6.0 ± 0.2 | qs pH 7.5 ± 0.2 | qs pH 7.5 ± 0.2 |
| Purified Water | | | qs 100 | qs 100 | qs 100 |
| Microorganism | | | Log Order Reductions | | |
| S. aureus | 6 | Hr | 5.0 | 4.7 | 5.0 |
| | 24 | Hr | 5.0 | 5.0 | 5.0 |
| | 7 | D | 5.0 | 5.0 | 5.0 |
| P. aeruginosa | 6 | Hr | 1.3 | 1.8 | 1.1 |
| | 24 | Hr | 1.5 | 2.7 | 1.5 |
| | 7 | D | 2.5 | 4.3 | 0.7 |
| E. coli | 6 | Hr | 0.5 | 0.5 | 0.9 |
| | 24 | Hr | 0.5 | 1.0 | 1.1 |
| | 7 | D | 3.6 | 2.2 | 1.6 |
| C. albicans | 7 | D | 3.2 | 3.2 | 1.2 |
| A. niger | 7 | D | 1.9 | 1.2 | 0.0 |

Compositions of Table 6 having N-dodecyl-2-pyrrolidone present alone (Q), and present with the preservative aid boric acid at both pH 7.5 (P) and at pH 6.0 (O) all fail the Ph. Eur. B criteria as set forth by Table 1. Therefore, N-dodecyl-2-pyrrolidone is insufficient as a sole agent for preservation. The preservative aid, boric acid, appears insufficient to enhance preservation activity of N-docecyl-2-pyrrolidone to meet the Ph. Eur. B criteria.

Table 7 presents anti-microbial preservation results with N-dodecyl-2-pyrrolidone in the presence of a cationic active, a cationic exchange resin and BAC. Formulations are made as for those of Table 6.

TABLE 7
Anti-Microbial Activity with N-Dodecyl-2-Pyrrolidone in the Presence of BAC

| | | | Concentration (w/v %) | | | |
|---|---|---|---|---|---|---|
| Ingredient | | | A (Control) | J | K | L |
| AL-37807 | | | 1 | 1 | 1 | 1 |
| Carbopol 974P | | | 0.2 | 0.2 | 0.2 | 0.2 |
| Amberlite IRP69 | | | 0.5 | 0.5 | 0.5 | 0.5 |
| Mannitol | | | 4.5 | 4.5 | 4.5 | — |
| Propylene Glycol | | | — | — | — | 1.8 |
| Edetate Disodium | | | 0.01 | 0.01 | 0.01 | 0.01 |
| BAC | | | 0.01 | 0.01 | 0.01 | 0.01 |
| 1-Dodecyl-2- | | | None | 0.0005 | 0.001 | 0.002 |
| Pyrrolidone | | | | | | |
| HCl or NaOH | | | qs pH 7.5 | qs pH 7.5 | qs pH 7.5 | qs pH 7.5 |
| Purified Water | | | qs 100 | qs 100 | qs 100 | qs 100 |
| Microorganism | | | Log Order Reductions | | | |
| S. aureus | 6 | Hr | 0.0 | 0.3 | 0.2 | 1.6 |
| | 24 | Hr | 0.2 | 1.4 | 2.5 | 5.0 |
| | 7 | D | 4.9 | 5.0 | 5.0 | 5.0 |
| | 14 | D | 4.9 | 5.0 | 5.0 | 5.0 |
| | 28 | D | 4.9 | 5.0 | 5.0 | 5.0 |
| P. aeruginosa | 6 | Hr | 5.0 | 5.0 | 5.1 | 5.1 |
| | 24 | Hr | 5.0 | 5.0 | 5.1 | 5.1 |
| | 7 | D | 5.0 | 5.0 | 5.1 | 5.1 |
| | 14 | D | 5.0 | 5.0 | 5.1 | 5.1 |
| | 28 | D | 5.0 | 5.0 | 5.1 | 5.1 |
| E. coli | 6 | Hr | 0.5 | 1.5 | 3.7 | 5.1 |
| | 24 | Hr | 2.3 | 5.0 | 5.1 | 5.1 |
| | 7 | D | 5.0 | 5.0 | 5.1 | 5.1 |
| | 14 | D | 5.0 | 5.0 | 5.1 | 5.1 |
| | 28 | D | 5.0 | 5.0 | 5.1 | 5.1 |
| C. albicans | 7 | D | 2.0 | 2.0 | 2.0 | 3.3 |
| | 14 | D | 2.6 | 2.0 | 2.2 | 3.5 |
| | 28 | D | 4.6 | 2.1 | 2.7 | 4.4 |
| A. niger | 7 | D | 0.3 | 0.8 | 0.8 | 1.0 |
| | 14 | D | 0.6 | 1.7 | 1.6 | 1.0 |
| | 28 | D | 1.7 | 2.4 | 2.7 | 2.0 |

Compositions of Table 7 having N-dodecyl-2-pyrrolidone and BAC present (i.e., J, K and L) pass the USP and Ph.Eur. B criteria as set forth by Table 1. In addition, the solubility of DDP is limited in aqueous solutions to 0.002%, unless enhanced by another surfactant as provided infra.

The preservation efficacy of DDP at various concentrations in combination with zinc chloride was examined as in Table 8.

TABLE 8
Anti-Microbial Activity of N-Dodecyl-2-Pyrrolidone
in the Presence of Zinc Chloride

| | | | Concentration (w/v %) | |
|---|---|---|---|---|
| Ingredient | | | S | T |
| Boric Acid | | | 0.3 | 0.3 |
| 1-Dodecyl-2-Pyrrolidone | | | 0.002 | 0.0005 |
| Sorbitol | | | 0.25 | 0.25 |
| Zinc Chloride | | | 0.0025 | 0.0025 |
| Propylene Glycol | | | 1.6 | 1.6 |
| NaOH and/or HCl | | | qs pH 6.0 ± 0.2 | qs pH 6.0 ± 0.2 |
| Purified Water | | | qs 100 | qs 100 |
| Microorganism | | | Log Order Reductions | |
| S. aureus | 6 | Hr | 4.7 | 1.9 |
| | 24 | Hr | 5.0 | 5.0 |
| | 7 | D | 5.0 | 5.0 |
| P. aeruginosa | 6 | Hr | 3.0 | 2.3 |
| | 24 | Hr | 3.2 | 2.6 |
| | 7 | D | 4.7 | 5.0 |
| E. coli | 6 | Hr | 4.5 | 3.6 |
| | 24 | Hr | 5.1 | 4.8 |
| | 7 | D | 5.1 | 5.1 |
| C. albicans | 7 | D | 2.6 | 1.4 |
| A. niger | 7 | D | 1.1 | 2.3 |

While 14-day and 28-day data are required for passing the Ph.Eur. B. standards, the data of Table 8 suggest that those criteria will be met; such an assay is provided infra.

The preservation efficacy of DDP in combination with zinc chloride in the presence of a nonionic active and a micelle-forming surfactant (HCO-40) was examined and the data are provided in Table 9. The surfactant is needed to ensure that the nonionic active is soluble and available for preservation efficacy.

TABLE 9
Anti-Microbial Activity of N-Docecyl-2-Pyrrolidone in
the Presence of Zinc, a Nonionic Active and HCO-40

| | | | Concentration (w/v %) | | | |
|---|---|---|---|---|---|---|
| Ingredient | | | U | V | W | X |
| Travoprost (AL06221) | | | 0.004 | 0.004 | 0.004 | 0.004 |
| HCO-40 | | | 0.1 | 0.1 | 0.1 | 0.1 |
| Boric Acid | | | 0.3 | 0.3 | 0.3 | 0.3 |
| 1-Dodecyl-2-Pyrrolidone | | | 0.001 | 0.01 | 0.02 | 0.05 |
| Zinc Chloride | | | 0.0025 | 0.0025 | 0.0025 | 0.0025 |
| Sorbitol | | | 0.25 | 0.25 | 0.25 | 0.25 |
| Propylene Glycol | | | 1.6 | 1.6 | 1.6 | 1.6 |
| NaOH and/or HCl | | | qs pH 6.0 ± 0.2 | qs pH 6.0 ± 0.2 | qs pH 6.0 0.2 | qs pH 6.0 ± 0.2 |
| Purified Water | | | qs 100 | qs 100 | qs 100 | qs 100 |
| Microorganism | | | Log Order Reductions | | | |
| S. aureus | 6 | Hr | 0.0 | 0.2 | 0.7 | 3.7 |
| | 24 | Hr | 0.0 | 2.9 | 4.2 | 5.1 |
| | 7 | D | 5.1 | 5.1 | 4.8 | 5.1 |
| | 14 | D | 5.1 | 5.1 | 4.8 | 5.1 |
| | 28 | D | 5.1 | 5.1 | 4.8 | 5.1 |
| P. aeruginosa | 6 | Hr | 1.1 | 2.0 | 1.7 | 2.3 |
| | 24 | Hr | 2.7 | 3.1 | 2.3 | 3.7 |
| | 7 | D | 5.1 | 5.1 | 4.9 | 5.1 |
| | 14 | D | 5.1 | 5.1 | 4.9 | 5.1 |
| | 28 | D | 5.1 | 5.1 | 4.9 | 5.1 |
| E. coli | 6 | Hr | 0.6 | 1.6 | 4.3 | 4.7 |
| | 24 | Hr | 1.4 | 3.8 | 5.0 | 5.0 |
| | 7 | D | 4.6 | 5.0 | 5.0 | 5.0 |
| | 14 | D | 5.0 | 5.0 | 5.0 | 5.0 |
| | 28 | D | 5.0 | 5.0 | 5.0 | 5.0 |
| C. albicans | 7 | D | 0.2 | 0.8 | 1.7 | 2.2 |
| | 14 | D | 0.7 | 1.1 | 1.8 | 2.4 |
| | 28 | D | 1.0 | 1.1 | 1.9 | 3.1 |
| A. niger | 7 | D | 2.8 | 2.7 | 1.8 | 1.8 |
| | 14 | D | 2.9 | 2.9 | 1.9 | 1.5 |
| | 28 | D | 2.8 | 2.7 | 1.7 | 2.7 |

The data of Table 9 suggest that the concentration of DDP at 0.001 w/v % (formulation U) is too low to be effective in the combination for passing the Ph.Eur. B criteria. While not wanting to be bound by theory, DDP may be also bound by micelles which binding would render the DDP less effective as a preservative. An efficacy test was also carried out as for composition V above where the concentration of surfactant HCO-40 was 0.05 w/v %; the resulting data indicate that such a composition passes the Ph. Eur. B criteria.

Formulations V, W, and X pass the Ph. Eur. B criteria demonstrating that the nonionic surfactant allows greater solubility of the DDP at higher concentrations of DDP and that the resultant combinations with zinc chloride have preservation efficacy.

The references cited herein, to the extent that they provide exemplary procedural or other details supplementary to those set forth herein, are specifically incorporated by reference.

Those of skill in the art, in light of the present disclosure, will appreciate that obvious modifications of the embodiments disclosed herein can be made without departing from the spirit and scope of the invention. All of the embodiments disclosed herein can be made and executed without undue experimentation in light of the present disclosure. The full scope of the invention is set out in the disclosure and equivalent embodiments thereof. The specification should not be construed to unduly narrow the full scope of protection to which the present invention is entitled.

As used herein and unless otherwise indicated, the terms “a” and “an” are taken to mean “one”, “at least one” or “one or more.”

What is claimed is:

1. A topically acceptable ophthalmic, otic or nasal composition, comprising:
5-(R₁)—N—(R₂)-2-pyrrolidone in an amount to have sufficient anti-bacterial and anti-fungal activity so as to meet antimicrobial preservation criteria set forth by European Pharmacopoeia 5.0 for parenteral and ophthalmic preparations,
wherein R₁ is H, methyl or ethyl, and
wherein R₂ is C₆-C₁₁ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; or
5-(R₁)—N—(R₂)-2-pyrrolidone in combination with benzalkonium chloride, benzadodecinium bromide, a zinc salt, polyquaternium-1, or N-octyl-2-pyrrolidone, wherein the combination is in an amount to have sufficient anti-bacterial and anti-fungal activity so as to meet antimicrobial preservation criteria set forth by European Pharmacopoeia 5.0 for parenteral and ophthalmic preparations;
wherein R₁ is H, methyl or ethyl, and
wherein R₂ is C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; and
a topically acceptable ophthalmic, otic or nasal carrier.

2. The composition of claim 1 further comprising an ophthalmic active, otic active, or nasal active.

3. A self-preserved topical composition comprising 5-(R₁)—N—(R₂)-2-pyrrolidone in an amount to have sufficient anti-bacterial and anti-fungal activity so as to meet antimicrobial preservation criteria set forth by European Pharmacopoeia 5.0 for parenteral and ophthalmic preparations,
wherein R₁ is H, methyl or ethyl, and
wherein R₂ is C₈ straight-chain, branched, substituted or unsubstituted alkyl, oxyalkyl, amidoalkyl, hydroxyalkyl, alkenyl, alkynyl, cycloalkyl, alkylcycloalkyl, or alkylaryl;
and a topically acceptable ophthalmic, otic or nasal carrier.

4. The composition of claim 3 wherein the 5-(R₁)—N—(R₂)-2-pyrrolidone is N-octyl-2-pyrrolidone.

5. The composition of claim 1 wherein the 5-(R₁)—N—(R₂)-2-pyrrolidone is N-dodecyl-2-pyrrolidone.

6. The composition of claim 3 further comprising a preservative aid selected from the group consisting of EDTA and boric acid.

7. The composition of claim 3 formulated for ophthalmic administration.

8. The composition of claim 3 formulated for otic administration.

9. The composition of claim 3 formulated for nasal administration.

10. The composition of claim 4 wherein the N-octyl-2-pyrrolidone is present in an amount of about 0.001 w/v % and about 0.05 w/v %.

11. The composition of claim 5 wherein the N-dodecyl-2-pyrrolidone is present in an amount of about 0.0005 w/v % and about 0.002 w/v %.

12. The composition of claim 5 wherein the N-dodecyl-2-pyrrolidone is present in combination with zinc.

13. The composition of claim 5 wherein the N-dodecyl-2-pyrrolidone is present in combination with benzalkonium chloride or polyquatemium-1.

14. In a method of preserving a topical composition from microbial contamination for use in ophthalmic, otic, or nasal administration, the improvement that comprises:
including 5-(R₁)—N—(R₂)-2-pyrrolidone in an amount to have sufficient anti-bacterial and anti-fungal activity so as to meet antimicrobial preservation criteria set forth by European Pharmacopoeia 5.0 for parenteral and ophthalmic preparations,
wherein R₁ is H, methyl or ethyl, and
wherein R₂ is C₆-C₁₁ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; or
including 5-(R₁)—N—(R₂)-2-pyrrolidone in combination with benzalkonium chloride, benzadodecinium bromide, a zinc salt, polyquatemium-1, or N-octyl-2-pyrrolidone, wherein the combination is in an amount to have sufficient anti-bacterial and anti-fungal activity so as to meet antimicrobial preservation criteria set forth by European Pharmacopoeia 5.0 for parenteral and ophthalmic preparations;
wherein R₁ is H, methyl or ethyl, and
wherein R₂ is C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl.

15. In a method of preserving a topical composition from microbial contamination for use in ophthalmic, otic, or nasal administration, the improvement that comprises: including N-octyl-2-pyrrolidone in an amount to have sufficient anti-bacterial and anti-fungal activity so as to meet antimicrobial preservation criteria set forth by European Pharmacopoeia 5.0 for parenteral and ophthalmic preparations.

16. A topically acceptable ophthalmic, otic or nasal composition, comprising:
5-(R₁)—N—(R₂)-2-pyrrolidone in an amount to have sufficient anti-bacterial and anti-fungal activity so as to meet antimicrobial preservation criteria set forth by United States Pharmacopoeia 24 for parenteral and ophthalmic preparations,
wherein R₁ is H, methyl or ethyl, and
wherein R₂ is C₈ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; and
a topically acceptable ophthalmic, otic or nasal carrier.

17. The composition of claim 16 wherein R₂ is C₈ straight-chain alkyl and the 5-(R₁)—N—(R₂)-2-pyrrolidone is N-octyl-2-pyrrolidone.

18. A topically acceptable ophthalmic, otic or nasal composition, comprising:
5-(R₁)—N—(R₂)-2-pyrrolidone in combination with benzalkonium chloride, benzadodecinium bromide, a zinc salt, polyquaternium-1, or N-octyl-2-pyrrolidone, wherein the combination is in an amount to have sufficient anti-bacterial and anti-fungal activity so as to meet antimicrobial preservation criteria set forth by United States Pharmacopoeia 24 for parenteral and ophthalmic preparations;
wherein R₁ is H, methyl or ethyl, and
wherein R₂ is C₁₂ straight-chain, branched, substituted or unsubstituted alkyl, oxyalkyl, amidoalkyl, hydroxyalkyl, alkenyl, alkynyl, cycloalkyl, alkylcycloalkyl, or alkylaryl; and
a topically acceptable ophthalmic, otic or nasal carrier.

19. The composition of claim 18 wherein R₂ is C₁₂ straight-chain alkyl and the 5-(R₁)—N—(R₂)-2-pyrrolidone is N-dodecyl-2-pyrrolidone.

20. The composition of claim 19 wherein the N-dodecyl-2-pyrrolidone is in combination with polyquaternium-1.
